(19) United States
(12) Patent Application Publication
(10) Pub. No.: US 2026/0028064 A1
(43) Pub. Date: Jan. 29, 2026

(54) VEHICLE HANDLE EXTENSION WITH AIR WAND

(71) Applicant: Ford Global Technologies, LLC, Dearborn, MI (US)

(72) Inventors: Stuart C. Salter, White Lake, MI (US); Jeffrey Robert Seaman, Petersburg, MI (US); Dawn Piechocki, Gross Pointe Park, MI (US); Annette Lynn Huebner, Highland, MI (US); Brendan Diamond, Naples, FL (US); Michael Sean Calkins, Macomb Township, MI (US); Cliff Standifer, Canton, MI (US)

(21) Appl. No.: 18/784,260

(22) Filed: Jul. 25, 2024

(51) Int. Cl. B62D 33/027

(52) U.S. Cl. CPC B62D 33/0273

(57) ABSTRACT

An assembly comprises a vehicle structure and a handle that is associated with the vehicle structure, wherein at least a portion of the handle comprises a hollow cavity. The handle is selectively moveable between a stowed position and a deployed position. An air wand is stored within the hollow cavity and is selectively removeable from the handle.

### TECHNICAL FIELD

This disclosure relates generally to an extendable handle that is associated with a moveable vehicle panel, and more specifically to an extendable handle that houses an air wand that is selectively detachable for connection to a compressor.

### BACKGROUND

Vehicles include cargo areas that are used to transport various types of items. A panel, such as a tailgate for example, is moveable between closed and open positions to facilitate access to the cargo area. Other features may be associated with the tailgate to provide additional content and to further facilitate access to the cargo area.

### SUMMARY

An assembly according to an exemplary aspect of the present disclosure includes, among other things: a vehicle structure; a handle that is associated with the vehicle structure, wherein the handle is selectively moveable between a stowed position and a deployed position, wherein at least a portion of the handle comprises a hollow cavity; and an air wand stored within the hollow cavity, the air wand being selectively removeable from the handle.

In a further non-limiting embodiment of any assembly, an end cap is attached to a distal end of the handle to close the hollow cavity when the air wand is in a stored position.

In a further non-limiting embodiment of any assembly, the end cap includes a lock that is moveable between a lock position and an unlock position.

In a further non-limiting embodiment of any assembly, the lock is resiliently biased to the lock position.

In a further non-limiting embodiment of any assembly, the air wand includes a nozzle and a wand handle that are aligned with each other and extend along a common axis when in a stored position.

In a further non-limiting embodiment of any assembly, the wand handle is selectively movable from the stored position to a deployed position where the nozzle and the wand handle are non-coaxial.

In a further non-limiting embodiment of any assembly, the air wand includes an input member that is selectively actuatable to unlock the air wand from the stored position to allow the wand handle to move to the deployed position, and once deployed, the input member is biased to return to a lock position to hold the wand handle in the deployed position.

In a further non-limiting embodiment of any assembly, the wand handle includes a compressor connector that comprises an air input, and wherein the nozzle comprises an air output, and wherein the air wand includes a valve that is selectively actuated by a trigger to control air flow between the air input and the air output.

In a further non-limiting embodiment of any assembly, a retainer bushing is positioned in the hollow cavity to receive a distal end of the nozzle when in the stored position.

In a further non-limiting embodiment of any assembly, the assembly includes at least one of: one or more sensors to determine a handle and/or an air wand position characteristic; an electronically controlled locking mechanism actuatable such that the handle and/or the air wand cannot be removed unless commanded by a control device; the nozzle being configurable to provide a variable airflow pattern.

An assembly according to an exemplary aspect of the present disclosure includes, among other things: a tailgate; a handle that is associated with the tailgate, wherein the handle is selectively moveable between a stowed position and a deployed position, and wherein the handle includes a tubular portion that provides a hollow cavity; an air wand stored within the hollow cavity, the air wand being selectively removeable from the handle; and an end cap attached to a distal end of the handle to close the hollow cavity when the air wand is in a stored position.

In a further non-limiting embodiment of any assembly, the end cap includes a lock that is moveable between a lock position and an unlock position, and wherein the lock is resiliently biased to the lock position.

In a further non-limiting embodiment of any assembly, the air wand includes a nozzle and a wand handle that are aligned with each other and extend along a common axis when in a stored position.

In a further non-limiting embodiment of any assembly, the air wand includes an input member that is selectively actuatable to unlock the air wand from the stored position to allow the wand handle to move to a deployed position where the nozzle and the wand handle are non-coaxial, and once deployed, the input member is biased to return to a lock position to hold the wand handle in the deployed position.

In a further non-limiting embodiment of any assembly, the wand handle includes a compressor connector that comprises an air input, and wherein the nozzle comprises an air output, and wherein the air wand includes a valve that is selectively actuated by a trigger to control air flow between the air input and the air output.

In a further non-limiting embodiment of any assembly, a retainer bushing is positioned in the hollow cavity to receive a distal end of the nozzle when in the stored position.

An method according to an exemplary aspect of the present disclosure includes, among other things: selectively moving a handle associated with a vehicle structure from a stowed position to a deployed position, wherein the handle includes a tubular portion that provides a hollow cavity; storing an air wand within the hollow cavity; and selectively removing the air wand from the handle.

In a further non-limiting embodiment of any method, the method includes closing a distal end of the tubular portion with an end cap when the air wand is in a stored position.

In a further non-limiting embodiment of any method, the air wand includes a nozzle and a wand handle that are aligned with each other and extend along a common axis when in the stored position.

In a further non-limiting embodiment of any method, the method includes selectively moving the wand handle from the stored position to a deployed position where the nozzle and the wand handle are non-coaxial.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle having a cargo area.

FIG. 2A is a schematic side view of a tailgate with an extendable handle in a first position.

FIG. 2B is similar to FIG. 2A but shows the extendable handle in a second position.

FIG. 2C shows a schematic representation of an air wand being removed from the extendable handle.

FIG. 3 is a perspective view of an example of a handle portion that houses an air wand.

FIG. 4 is a section view of the handle/air wand of FIG. 3 and shows a retainer bushing.

FIG. 5A is a section view of an end cap for the handle that includes a lock that is in a locked position.

FIG. 5B is similar to that of FIG. 5A but shows the lock in an unlocked position.

FIG. 6A is a perspective view of an end of the handle with the end cap in an open position.

FIG. 6B is an end view of the handle with the end cap in an open position and with the lock in a locked position.

FIG. 6C is an end view of the handle with the end cap in an open position and with the lock in an unlocked position.

FIG. 7A is a side view of one example of a linear air wand.

FIG. 7B is a side view of another example of a linear air wand.

FIG. 8A is a side view of another example of an air wand that includes a pivotable handle portion.

FIG. 8B is a section view of the air wand of FIG. 8A.

FIG. 9 is a side view of the air wand of FIG. 8A in a deployed state.

FIG. 10 is an enlarged section view of a valve and trigger for the air wand.

FIG. 11 is a perspective view of a button used to move the handle portions relative to each other.

FIG. 12A is a perspective view of the valve of FIG. 10.

FIG. 12B is a section view of the valve of FIG. 12A in a closed position.

FIG. 12C is a section view of the valve of FIG. 12A in an open position.

### DETAILED DESCRIPTION

This disclosure details a system and method where an extendable handle is associated with a moveable vehicle panel, and more specifically to an extendable handle that houses an air wand that is selectively detachable for connection to a compressor.

FIG. 1 illustrates a vehicle 10 that includes a passenger compartment 12 and a cargo bed area 14 that is aft the passenger compartment 12. In this example, the vehicle 10 is a pickup truck. The vehicle 10 could be another type of vehicle in another example, such as a car, van, sport utility vehicle, etc. In this example, the cargo bed area 14 is defined by a rear wall 16, a moveable vehicle structure, e.g., moveable wall/panel, tailgate 18, etc., and a pair of opposing side walls 20 that extend between the rear wall 16 and the tailgate 18. The cargo bed area 14 further includes a bottom surface 22 that can support various items. In this example, the tailgate 18 is selectively moveable relative to the truck bed side walls 20 between an open position (FIG. 1) and a closed position.

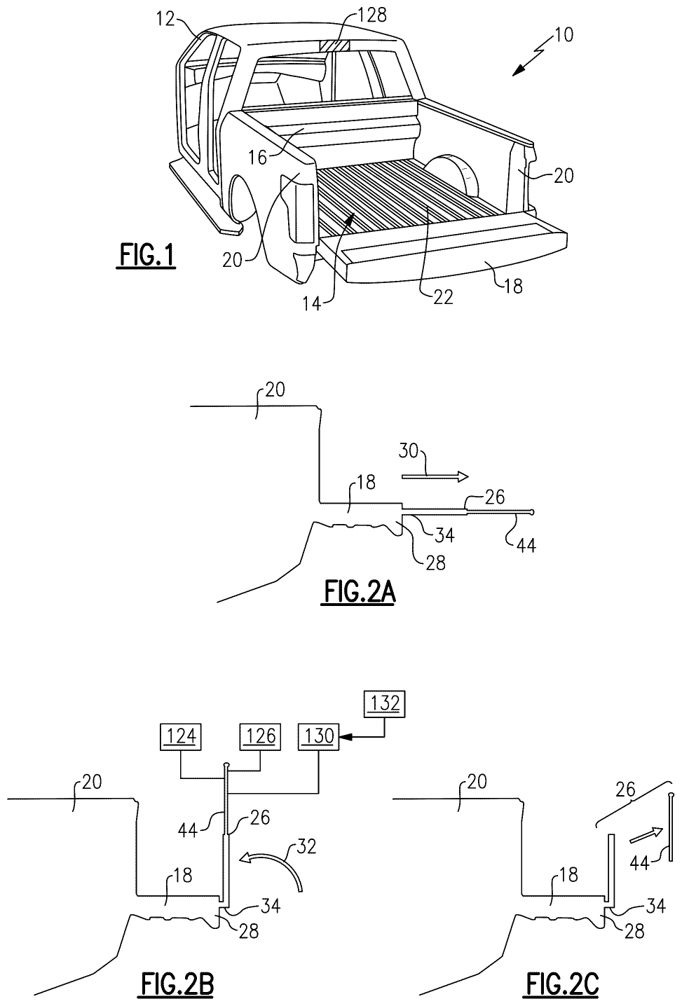

When the tailgate 18 is in the open position as shown in FIG. 2A, a handle 26 is selectively extended from a distal end 28 of the tailgate as indicated by arrow 30. The handle 26 can then be pivoted to an upright position, as indicated by arrow 32 in FIG. 2B, and locked into place. This handle 26 can then function as a grasping member to facilitate a user in climbing up into the cargo bed area 14, for example. In one example, the disclosure provides for at least a portion 34 of the handle 26 to be to house a component that is selectively removable from a vehicle structure, such as the tailgate 18, for example. In one example, the portion 34 houses an air wand 44 that can be removed as shown in FIG. 2C.

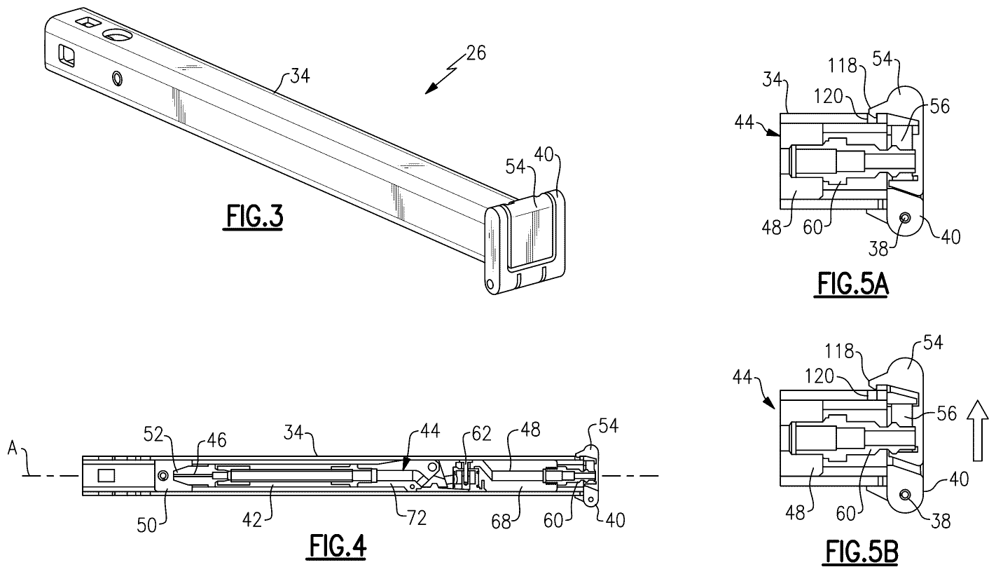

In implementations, an end cap 40 (FIG. 3) is mounted to a distal end of the portion 34 of the handle 26 via a pivot connection 38 to enclose a hollow cavity 42 (FIG. 4).

In implementations, an air wand 44 is stored within the hollow cavity 42. FIG. 4 shows the air wand 44 in a stored position. The air wand 44 can be selectively removeable from the handle 26 for connection to a compressor (not shown). The end cap 40 closes the hollow cavity 42 when the air wand 44 is in the stored position.

In implementations, the air wand 44 includes a nozzle 46 and a wand handle 48 that are aligned with each other and extend along a common axis A when in the stored position as shown in FIG. 4.

In implementations, a retainer bushing 50 is positioned in the hollow cavity 42 to receive a distal end 52 of the nozzle 46 when in the stored position as shown in FIG. 4.

In implementations, the end cap 40 includes a lock 54 that is moveable between a lock position (FIG. 5A) and an unlock position (FIG. 5B).

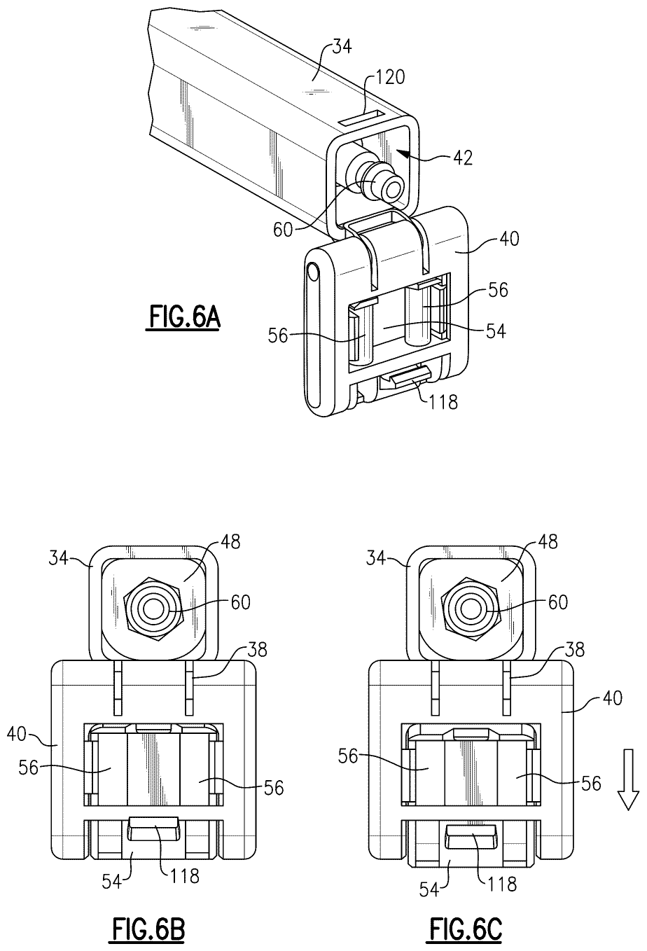

As best shown in FIG. 6A, in one example, the end cap 40 includes one or more resilient members 56 that resiliently bias the lock 54 to a desired position. In one example, the resilient members 56 comprise coil/compression springs or other similar structures. FIG. 6B shows the end cap 40 in an open position with the springs in a first or less compressed state and the lock 54 in a first position. FIG. 5A shows the end cap 40 in a closed position with the springs in the first or less compressed state and the lock 54 is in the locked position. FIG. 6C shows the end cap 40 in an open position with the springs in a second or more compressed state and the lock 54 is in a second position, e.g. extended position. FIG. 5B shows the end cap 40 in a closed position with the springs in the second or more compressed state and the lock 54 is in the unlocked position.

In implementations, the lock 54 is resiliently biased to the lock position as shown in FIG. 5B.

Once the lock 54 is in the unlocked position and the end cap 40 is in the open position, the air wand 44 can be selectively removed from the handle 26.

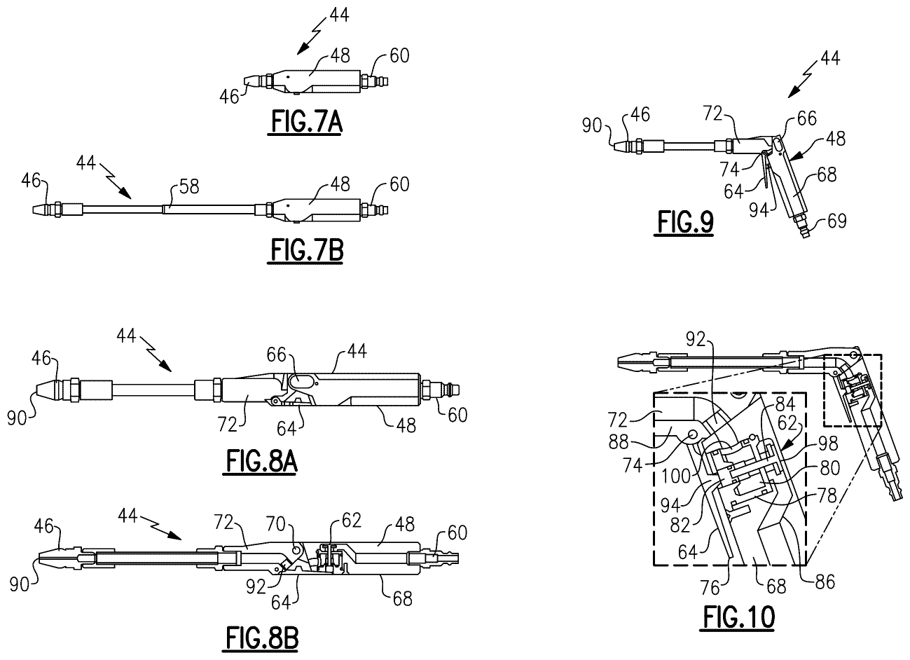

FIG. 7A shows one example of an air wand 44 including the nozzle 46 and the wand handle 48. In this example, the air wand 44 has a shorter length.

FIG. 7B one example of an air wand 44 including the nozzle 46 and the wand handle 48. In this example, the air wand 44 has a longer length due to a tubular portion 58 that interconnects the nozzle 46 and the wand handle 48.

The examples of FIGS. 7A-7B show a simplified design where the air wand 44 remains in the position where the nozzle 46 and wand handle 48 are aligned with each other and extend along a common axis A. Thus, the air wand 44 has the same configuration when in the stored position and when in the removed position.

In implementations, the wand handle 48 includes a compressor connector 60 that comprises an air input and wherein the nozzle 46 comprises an air output.

In implementations, the air wand 44 includes a valve 62 that is selectively actuated by a trigger 64 (FIGS. 8A-B) to control air flow between the air input and the air output.

FIGS. 8A-8B and 9-10 show an example where the wand handle 48 is moveable relative to the nozzle 46. In implementations, the wand handle 48 is selectively movable from the stored position to a deployed position where the nozzle 46 and the wand handle 48 are non-coaxial as shown in FIG. 9.

In implementations, the air wand 44 includes an input member 66 that is selectively actuatable to unlock the air wand 44 from the stored position to allow the wand handle 48 to move to the deployed position. Once deployed, the input member 66 is biased to return to a lock position to hold the wand handle 48 in the deployed position as shown in FIG. 9.

To move to the deployed position, a first portion 68 of the handle 48, e.g., the portion 68 with the compressor connector 60, pivots at a pivot connection 70 relative to a second portion 72 of the handle 48, e.g., the portion with the nozzle 46.

FIG. 10 is a section view of the valve 62 in relation to the trigger 64 when the wand 44 is in the deployed position. FIG. 9 shows the trigger 64 in a “wand OFF” condition and FIG. 10 shows the trigger 64 in a “wand ON” condition.

In implementations, the trigger 64 is pivotally connected at 74 to the second portion 72 of the handle 48. In one example, the trigger 64 comprises an elongated body with one end at the pivot connection 74 and a distal end 76 that can be selectively actuated by a user to a “wand ON” position. In one example, the trigger 64 is resiliently biased at the pivot connection 74 to the “wand OFF” position.

In implementations, the valve 62 comprises a cylindrical valve housing 78 with an inner chamber 80 that receives a piston 82 associated with a rod 84. The first portion 68 of the handle 48 includes an inlet air passage 86 and the second portion 72 of the handle 48 includes an outlet air passage 88 that is fluidly connected to an outlet 90 from the nozzle 46. In one example, a bushing/gasket/face seal 92 is associated with the outlet air passage 88 at a location between the handle portions 68, 72 to further facilitate sealing along the air outlet passage 88 when the first portion 68 of the handle 48 is moved to the deployed position.

In implementations, a button or protrusion 94 is located on a rear facing side of the trigger 64 at a location between the pivot connection 74 and the distal end 76. When the distal end 76 is compressed in a direction toward the first portion 68 of the handle 48, the protrusion 94 presses against the piston 82 to move the valve 62 to an open position (FIG. 10) where the inlet air passage 86 can connect to the outlet air passage 88 via ports 96 formed in an upper surface of cylindrical housing 78.

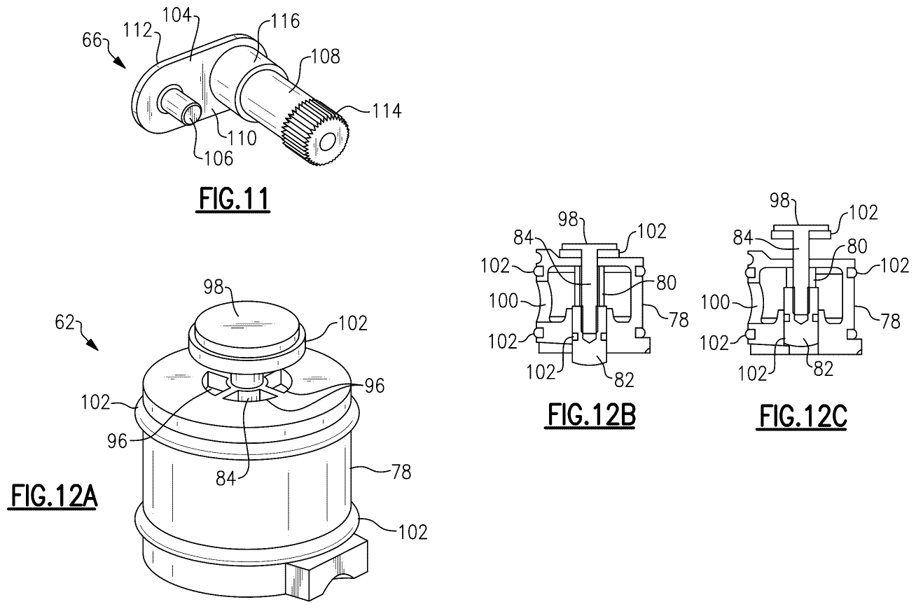

In one example, one end of the rod 84 is coupled to the piston 82 and an opposite end of the rod 84 is coupled to an enlarged head 98. When the valve 62 is in the open position (sec FIGS. 10, 12A, and 12C) the enlarged head 98 is moved away from the upper surface of the cylindrical housing 78 to open the ports 96 as best shown in FIG. 12A. When the ports 96 are open air can flow through the compressor connector 60 into the air inlet passage 86, and then through the ports 96 which direct air flow into the inner chamber 80 where air flow can then exit through an outlet port 100 into the air outlet passage 88. When the valve 62 is in the closed position, the enlarged head 98 is moved toward the upper surface of the cylindrical housing 78 to cover/seal the ports 96 (see FIGS. 9 and 12B).

In implementations, the valve 62 includes one or more seals 102 to provide a sealed interfaces between the cylindrical housing 78 and the handle 48, and between the piston 82 and the cylindrical housing 78.

FIG. 11 shows one example of the input member 66 that is selectively actuatable to unlock the air wand 44 from the stored position to allow the wand handle 48 to move to the deployed position. In implementations, the input member 66 comprises a button body 104 with a locating feature 106 and a resiliently biased lock member 108 extending outwardly of one side 110 of the button body 104. The opposite side 112 of the button body 104 comprises a surface that can be selectively compressed by a user to lock/unlock the handle portions 68, 72 to allow the handle 48 to move back and forth between the deployed and stored positions.

In implementations, the locating feature 106 facilitates and maintains the button body 104 in position within the handle 48.

In implementations, lock member 108 extends to a geared or splined interface 114 that cooperates with a corresponding geared or splined interface (not shown) inside the first portion 68 of the handle 48. A resilient member 116, such as a compression/coil spring for example, resiliently biases the splined interface 114 of the lock member 108 into engagement with the splined interface inside the first portion 68 of the handle 48. This prevents the first handle portion 68 and second handle portion 72 from moving relative to each other. When the button body 104 is compressed/depressed, the biasing force is overcome and the splined interface 114 of the lock member 108 is moved out of engagement with the splined interface inside the first portion 68 of the handle 48. This allows the first handle portion 68 and second handle portion 72 to move relative to each other between the stored and deployed positions. Once the handle portions 68, 72 are in the desired position (stored or deployed), the button body 104 is released and the splines are reengaged with each other via the resilient biasing force of the resilient member 116.

In implementations, the tubular portion 34 of the handle 26, which may comprise a square tube, rectangular tube, round tube, oval tube, etc., is slid outward from the tailgate 18 as shown in FIG. 2A. The end cap 40 (FIG. 3) may then be unlocked then rotated away from the end of the tubular portion 34 to expose a rearward portion of the wand 44 which extends partially beyond an end of the tubular portion 34, and which can be removed from the tubular portion 34 as shown in FIGS. 2B-2C. To unlock the end cap 40 from the tubular portion 34, the lock 54, which has a hook feature 118 that engages a slot 120 on the tubular portion 34, is slid away in a generally perpendicular direction from a face of the tubular portion 34 that has the slot 120 (see FIGS. 5A-B). The hook feature 118 is part of the lock 54, which is fixed to the end cap 40 via slots to allow the lock 54 to translate enough to free the hook 118 from the slot 120. The lock 54 is biased towards the slot 120 of the tubular portion 34 by way of resilient members 56 located on an underside of the lock 54.

Once the end cap 40 is in the open position, the air wand 44 can be pulled out from the tubular portion 34.

Next, the actuator member 66 can be pressed to disengage the button locking gear splined interface 114 from the gear splined interface inside the handle. In one example, the splined interface 114 of the button body member 104 has a male involuted spline on its circumference located on one end which couples the handle portions 68, 72 together via mating female involuted splines associated with both the handle portions 68, 72. This allows the first portion 68 to rotate relative to the second portion 72. In one example, upon rotating the first portion 68 a maximum amount, the button body 104 is released which then locks the first portion 68 relative to the second portion 72 at an orientation where the portions 68, 72 are fixed relative to each other at approximately 110 degrees, for example. Other orientations may also be used. The resilient member 116 keeps the button locking gear splined interface 114 engaged.

It should be noted that when this operation is complete, the inner cavities, e.g., air passages 86, 88, of both the first portion 68 and the second portion 72 align with each other, and thus the face seal 92 that is fixed to the second portion 72 is then compressed against a mating side of the first portion 68 of the handle 48. This prevents compressed air escaping in this transition arca.

One in this position, a compressed air supply may be connected to the air wand 44 via the compressor connector 60. At this point the air wand 44 is ready to use. When the trigger 64, is actuated, the protrusion 94 of the trigger 64 contacts the outer surface of the piston 82 and displaces the seal 102 associated with the enlarged head 98 of the rod 84 away from the upper portion of the cylindrical valve housing 78. This allows compressed air to travel from a rear portion of the handle 48 through a cavity centrally located within the handle 48, and then into the ports 96 located at the upper portion of the cylindrical valve housing 78, and then out through the outlet port 100 located in the cylindrical valve housing 78, and then to a front portion of the handle 48, and then to the nozzle 46. Releasing the trigger 64 causes a compression spring within the cylindrical valve housing 78 to return the piston 82 to the original position thereby causing the enlarged head 98 of the rod 84 to seal the ports 96.

The subject disclosure provides for an air wand 44 that can be easily incorporated into a tailgate handle. This prevents the air wand from comprising loose equipment that could be broken or lost if simply left in the cargo area 14. The air wand is easy to pull out, and may include and additional spring (not shown) that can be at bottom of the handle to spring load the air wand so that it pops up when unlocked. The wand may also include a telescoping feature to adjust wand length.

In implementations, the wand may include a BLE tag 124 such that a user can check to see if the wand has been returned to the vehicle.

In implementations, the vehicle could use a position sensor 126 for the handle 26 to determine if it is in an upright position, and/or when a top part of the handle is attached to a bottom portion. In one example, the position sensor 126 could also be located inside the top part of the handle to determine if the air wand is in the handle.

In implementations, a CHMSL camera 128 can monitor use and remind users to replace the handle and/or air wand when work is completed.

In implementations, a variable pattern may be provided where an end of the wand can comprise a screw in needle valve such that as the nozzle is rotated, a needle can be moved inward or outward to allow for the airflow pattern to be focused and/or cone shaped/dispersed.

In implementations, electronically controlled locking mechanism 130 can be built in such that the tailgate handle and/or the air wand cannot be removed unless commanded to do so from the a key fob or other vehicle controls 132.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly comprising:
a vehicle structure;
a handle that is associated with the vehicle structure, wherein the handle is selectively moveable between a stowed position and a deployed position, wherein at least a portion of the handle comprises a hollow cavity; and
an air wand stored within the hollow cavity, the air wand being selectively removeable from the handle.

2. The assembly of claim 1, including an end cap attached to a distal end of the handle to close the hollow cavity when the air wand is in a stored position.

3. The assembly of claim 2, wherein the end cap includes a lock that is moveable between a lock position and an unlock position.

4. The assembly of claim 3, wherein the lock is resiliently biased to the lock position.

5. The assembly of claim 1, wherein the air wand includes a nozzle and a wand handle that are aligned with each other and extend along a common axis when in a stored position.

6. The assembly of claim 5, wherein the wand handle is selectively movable from the stored position to a deployed position where the nozzle and the wand handle are non-coaxial.

7. The assembly of claim 6, wherein the air wand includes an input member that is selectively actuatable to unlock the air wand from the stored position to allow the wand handle to move to the deployed position, and once deployed, the input member is biased to return to a lock position to hold the wand handle in the deployed position.

8. The assembly of claim 5, wherein the wand handle includes a compressor connector that comprises an air input, and wherein the nozzle comprises an air output, and wherein the air wand includes a valve that is selectively actuated by a trigger to control air flow between the air input and the air output.

9. The assembly of claim 5, including a retainer bushing positioned in the hollow cavity to receive a distal end of the nozzle when in the stored position.

10. The assembly of claim 5, including at least one of:
one or more sensors to determine a handle and/or an air wand position characteristic;
an electronically controlled locking mechanism actuatable such that the handle and/or the air wand cannot be removed unless commanded by a control device;
the nozzle being configurable to provide a variable airflow pattern.

11. An assembly comprising:
a tailgate;
a handle that is associated with the tailgate, wherein the handle is selectively moveable between a stowed position and a deployed position, and wherein the handle includes a tubular portion that provides a hollow cavity;
an air wand stored within the hollow cavity, the air wand being selectively removeable from the handle; and
an end cap attached to a distal end of the handle to close the hollow cavity when the air wand is in a stored position.

12. The assembly of claim 11, wherein the end cap includes a lock that is moveable between a lock position and an unlock position, and wherein the lock is resiliently biased to the lock position.

13. The assembly of claim 11, wherein the air wand includes a nozzle and a wand handle that are aligned with each other and extend along a common axis when in a stored position.

14. The assembly of claim 13, wherein the air wand includes an input member that is selectively actuatable to unlock the air wand from the stored position to allow the wand handle to move to a deployed position where the nozzle and the wand handle are non-coaxial, and once deployed, the input member is biased to return to a lock position to hold the wand handle in the deployed position.

15. The assembly of claim 13, wherein the wand handle includes a compressor connector that comprises an air input, and wherein the nozzle comprises an air output, and wherein the air wand includes a valve that is selectively actuated by a trigger to control air flow between the air input and the air output.

16. The assembly of claim 13, including a retainer bushing positioned in the hollow cavity to receive a distal end of the nozzle when in the stored position.

17. A method comprising:
selectively moving a handle associated with a vehicle structure from a stowed position to a deployed position, wherein the handle includes a tubular portion that provides a hollow cavity;
storing an air wand within the hollow cavity; and
selectively removing the air wand from the handle.

18. The method of claim 17, including closing a distal end of the tubular portion with an end cap when the air wand is in a stored position.

19. The method of claim 18, wherein the air wand includes a nozzle and a wand handle that are aligned with each other and extend along a common axis when in the stored position.

20. The method of claim 19, including selectively moving the wand handle from the stored position to a deployed position where the nozzle and the wand handle are non-coaxial.
